(19) United States
(12) Patent Application Publication
(10) Pub. No.: US 2026/0105888 A1
(43) Pub. Date: Apr. 16, 2026

(54) POWER SUPPLY DEVICE, DISPLAY DEVICE INCLUDING SAME, AND ELECTRONIC DEVICE INCLUDING SAME

(71) Applicants: Samsung Display Co., Ltd., Yongin-si (KR); Korea Advanced Institute of Science and Technology, Daejeon (KR)

(72) Inventors: Yong Jae LEE, Yongin-si (KR); Jae Hyun KIM, Daejeon (KR); Dong Kyu KIM, Yongin-si (KR); Sung Chun PARK, Yongin-si (KR); Hyun Sik KIM, Daejeon (KR)

(21) Appl. No.: 19/232,619

(22) Filed: Jun. 9, 2025

(30) Foreign Application Priority Data
Oct. 10, 2024 (KR) 10-2024-0138037
Jan. 3, 2025 (KR) 10-2025-0001088

(51) Int. Cl. G09G 3/3233; G09G 3/3291; H02M 3/158

(52) U.S. Cl. CPC G09G 3/3233; H02M 3/158; G09G 3/3291; G09G 2320/0247; G09G 2330/021; G09G 2330/028

(57) ABSTRACT

A power supply device includes: a switching block connected between an input node receiving an input power and a switching node outputting a switching voltage, the switching block converting the input power into the switching voltage by transistors being turned on/off based on a first control signal and a second control signal; an inductor connected between the switching node and an output node outputting an output power; and an output capacitor connected between the output node and a ground node receiving a ground power, wherein when an on duty ratio of each of the first control signal and the second control signal is greater than a reference value, a voltage level of the output power is greater than the input power, and when the on duty ratio is less than or equal to the reference value, the voltage level of the output power is less than the input power.

### CROSS-REFERENCE TO RELATED APPLICATION

The present application claims priority to and the benefits of Korean Patent Application Number 10-2024-0138037, filed on Oct. 10, 2024, and Korean Patent Application Number 10-2025-0001088, filed on Jan. 3, 2025, in the Korean Intellectual Property Office, the entire disclosures of each of which are incorporated herein by reference.

### BACKGROUND

### 1. Field

Aspects of some embodiments of the present disclosure relate to a power supply device, a display device including the same, and an electronic device including the same.

### 2. Description of the Related Art

A display device may include a power supply device which generates high potential output power and low potential output power necessary for driving pixels by converting input power supplied from the outside. The power supply device may supply the generated positive power and negative power to a display panel of the display device through power supply lines.

The power supply device may use a boost converter to generate the high potential output power and a buck converter to generate the low potential output power. Thus, there is a demand for a DC-DC converter circuit that can smoothly switch modes between the boost converter and the buck converter and has a low output ripple.

The above information disclosed in this Background section is only for enhancement of understanding of the background and therefore the information discussed in this Background section does not necessarily constitute prior art.

### SUMMARY

Aspects of some embodiments of the present disclosure include a display device including a DC-DC converter circuit that may be capable of relatively smoothly switching modes between a boost converter and a buck converter and may have a relatively low output ripple.

According to some embodiments of the present disclosure, a power supply device may include a switching block connected between an input node receiving an input power and a switching node outputting a switching voltage, the switching block converting the input power into the switching voltage by transistors being turned on/off based on a first control signal and a second control signal, an inductor connected between the switching node and an output node outputting an output power, and an output capacitor connected between the output node and a ground node receiving a ground power. According to some embodiments, when an on duty ratio of each of the first control signal and the second control signal is greater than a reference value, a voltage level of the output power may be greater than a voltage level of the input power, and when the on duty ratio is less than or equal to the reference value, the voltage level of the output power may be less than the voltage level of the input power.

In one or more embodiments, when the on duty ratio is greater than the reference value, the switching voltage may have a voltage level between the voltage level of the input power and twice the voltage level of the input power, and when the on duty ratio is less than or equal to the reference value, the switching voltage may have the voltage level between a voltage level of the ground power and the voltage level of the input power.

In one or more embodiments, as the on duty ratio increases from zero to one, the voltage level of the output power may continuously increase from the voltage level of the ground power to twice the voltage level of the input power.

In one or more embodiments, a phase difference between the first control signal and the second control signal may be 180 degrees.

In one or more embodiments, the reference value may be 0.5.

In one or more embodiments, the switching block may include a first transistor coupled between the input node and a first node, the first transistor including a gate electrode receiving the first control signal, a first capacitor connected between the first node and a second node, a second transistor connected between the second node and the switching node, the second transistor including a gate electrode receiving the second control signal, a third transistor coupled between the second node and the input node, the third transistor including a gate electrode receiving a third control signal, a fourth transistor connected between the switching node and the first node, the fourth transistor including a gate electrode receiving a fourth control signal, and a fifth transistor coupled between the first node and the ground node, the fifth transistor including a gate electrode receiving a fifth control signal.

In one or more embodiments, when the first control signal has a logic high level, the first transistor may be turned on, and when the second control signal has a logic high level, the second transistor may be turned on.

In one or more embodiments, the third control signal may control the third transistor to be turned on or off alternately with the first transistor, the fourth control signal may control the fourth transistor to be turned on or off alternately with the second transistor, and the fifth control signal may control the fifth transistor to be turned on or off alternately with the first transistor.

In one or more embodiments, when the on duty ratio is greater than the reference value, a switching cycle may include first to fourth consecutive intervals, and during the first interval and the third interval, the first transistor and the second transistor may be turned on, the third transistor, the fourth transistor, and the fifth transistor may be turned off, and the switching voltage may be twice the voltage level of the input power.

In one or more embodiments, during the second interval after the first interval, the first transistor and the fourth transistor may be turned on; the second transistor, the third transistor, and the fifth transistor may be turned off; and the switching voltage may have the voltage level of the input power.

In one or more embodiments, during a fourth interval after a third interval, the second transistor, the third transistor, and the fifth transistor may be turned on; the first transistor and the fourth transistor may be turned off; and the switching voltage may have the voltage level of the input power.

In one or more embodiments, when the on duty ratio is less than or equal to the reference value, the switching cycle may include fifth to eighth consecutive intervals, and during the fifth interval, the first transistor and the fourth transistor may be turned on; the second transistor, the third transistor, and the fifth transistor may be turned off; and the switching voltage may have the voltage level of the input power.

In one or more embodiments, during a sixth interval after the fifth interval and the eighth interval after a seventh interval, the third transistor, the fourth transistor, and the fifth transistor may be turned on; the first transistor and the second transistor may be turned off; and the switching voltage may have the voltage level of the ground power.

In one or more embodiments, during the seventh interval after the sixth interval, the second transistor, the third transistor, and the fifth transistor may be turned on; the first transistor and the fourth transistor may be turned off; and the switching voltage may have the voltage level of the input power.

According to an aspect of embodiments of the present disclosure, a display device may include a display panel including scan lines, a first power supply line, a second power supply line, and pixels connected to the scan lines and the first and second power supply lines, a scan driver sequentially providing scan signals to the scan lines, and a power supply converting an input power into a first power supply voltage and a second power supply voltage, supplying the first power supply voltage to the first power supply line, and supplying the second power supply voltage to the second power supply line. According to some embodiments, the power supply may include a switching block connected between an input node receiving the input power and a switching node outputting a switching voltage, the switching block converting the input power into the switching voltage by transistors being turned on/off based on a first control signal and a second control signal, an inductor connected between the switching node and an output node outputting an output power, and an output capacitor connected between the output node and a ground node receiving a ground power. According to some embodiments, when an on duty ratio of each of the first control signal and the second control signal may be greater than a reference value, a voltage level of the output power is greater than a voltage level of the input power, and when the on duty ratio is less than or equal to the reference value, the voltage level of the output power may be less than the voltage level of the input power.

In one or more embodiments, when the on duty ratio is greater than the reference value, the switching voltage may have a voltage level between the voltage level of the input power and twice the voltage level of the input power, and when the on duty ratio is less than or equal to the reference value, the switching voltage may have the voltage level between a voltage level of the ground power and the voltage level of the input power.

In one or more embodiments, as the on duty ratio increases from zero to one, the voltage level of the output power may continuously increase from the voltage level of the ground power to twice the voltage level of the input power.

In one or more embodiments, the reference value may be 0.5.

According to an aspect of embodiments of the present disclosure, an electronic device may include a processor, and a display device including pixels, the display device displaying an image on the pixels in response to control of the processor. According to some embodiments, the display device may include a display panel including scan lines, a first power supply line, a second power supply line, and the pixels connected to the scan lines, the first power supply line, and the second power supply line, a scan driver sequentially providing scan signals to the scan lines, and a power supply converting an input power into a first power supply voltage and a second power supply voltage, supplying the first power supply voltage to the first power supply line, and supplying the second power supply voltage to the second power supply line. According to some embodiments, the power supply may include: a switching block connected between an input node receiving the input power and a switching node outputting a switching voltage, the switching block converting the input power to the switching voltage by transistors being turned on/off based on a first control signal and a second control signal, an inductor connected between the switching node and an output node outputting an output power, and an output capacitor connected between the output node and a ground node receiving a ground power. According to some embodiments, when an on duty ratio of each of the first control signal and the second control signal is greater than a reference value, a voltage level of the output power may be greater than a voltage level of the input power, and when the on duty ratio is less than or equal to the reference value, the voltage level of the output power may be less than the voltage level of the input power.

In one or more embodiments, when the on duty ratio is greater than the reference value, the switching voltage may have a voltage level between the voltage level of the input power and twice the voltage level of the input power, and n when the on duty ratio is less than or equal to the reference value, the switching voltage may have the voltage level between a voltage level of the ground power and the voltage level of the input power.

### BRIEF DESCRIPTION OF THE DRAWINGS

The above and other aspects and features of some embodiments according to the present disclosure will become more apparent by describing, in further detail, aspects of some embodiments thereof with reference to the accompanying drawings, in which:

FIG. 1 is a block diagram illustrating a display device according to some embodiments of the present disclosure.

FIG. 2 is a block diagram illustrating aspects of a power supply included in the display device of FIG. 1.

FIG. 3 is a block diagram illustrating further details of a switching circuit of FIG. 2 according to some embodiments.

FIG. 4 is a timing diagram of a first control signal and a second control signal according to some embodiments.

FIGS. 5 to 7 are circuit diagrams showing aspects of an operating process of a switching circuit according to signals of FIG. 4.

FIG. 8 is a timing diagram of a first control signal and a second control signal according to some embodiments.

FIGS. 9 to 11 are circuit diagrams showing operating processes of a switching circuit according to signals of FIG. 8.

FIG. 12 is a graph showing a voltage conversion ratio of a DC-DC converter according to some embodiments of the present disclosure.

FIG. 13 is a graph showing an on duty ratio and an output power according to some embodiments of the present disclosure.

FIG. 14 is a block diagram illustrating aspects of a switching circuit of FIG. 2 according to some embodiments.

FIGS. 15 to 17 are timing diagrams of a first control signal, a second control signal, and a third control signal according to some embodiments.

FIG. 18 is a graph showing a voltage conversion ratio of a DC-DC converter according to some embodiments of the present disclosure.

FIG. 19 is a block diagram illustrating an electronic device according to some embodiments of the present disclosure.

FIG. 20 is a diagram illustrating an example in which the electronic device of FIG. 19 is a smartphone.

### DETAILED DESCRIPTION

Herein, some aspects of some embodiments of the present disclosure will be described in further detail with reference to the accompanying drawings. It is noted that in the following description, the parts necessary to understand the operation according to the present disclosure will be described, and descriptions of other parts may be omitted in order to not obscure the gist of the present disclosure. In addition, embodiments according to the present disclosure are not limited to the embodiments described herein and may be embodied in other forms. The embodiments described herein are provided to explain the present disclosure in further detail so as to enable those skilled in the art to easily implement the technical idea of the present disclosure.

Throughout the specification, in a case in which a portion is “connected” to another portion, the case includes not only a case in which the portion is directly connected but also a case in which the portion is indirectly connected with one or more other elements interposed therebetween. Terms used herein are for describing specific embodiments and are not intended to limit the present disclosure. Throughout the specification, in a case in which a certain portion “includes,” the case means that the portion may further include another component without excluding another component unless otherwise stated. “At least one of X, Y, and Z,” “at least one of X, Y, or Z,” and “at least one selected from the group consisting of X, Y, and Z” may be construed as X only, Y only, Z only, any combination of two or more of X, Y, and Z, such as, for instance, XYZ, XYY, YZ, and ZZ, or any variation thereof. The term “and/or” includes any and all combinations of one or more of the associated listed items.

Here, terms such as “first” and “second” may be used to describe various components, but these components are not limited to these terms. These terms are used to distinguish one component from another component. Therefore, a “first” component may refer to a second component within a range without departing from the scope disclosed herein.

Spatially relative terms, such as “under,” “on,” and the like may be used for descriptive purposes, thereby describing a relationship between one element or feature and another element(s) or feature(s) as shown in the drawings. Spatially relative terms are intended to include other directions in use, in operation, and/or in manufacturing, in addition to the direction depicted in the drawings. For example, when a device shown in the drawing is turned upside down, elements depicted as being positioned “under” other elements or features are positioned in a direction “on” the other elements or features. Therefore, in the present disclosure, the term “under” may include both directions of on and under. In addition, the device may face in other directions (for example, rotated 90 degrees or in other directions) and, thus, the spatially relative terms used herein are interpreted according thereto.

Various embodiments are described with reference to drawings schematically illustrating example or ideal embodiments. Accordingly, it will be expected that shapes may vary, for example, according to tolerances and/or manufacturing techniques. Therefore, the embodiments disclosed herein are not to be construed as being limited to shown specific shapes, and are to be interpreted as including, for example, changes in shapes that may occur as a result of manufacturing. As described above, the shapes shown in the drawings may not show actual shapes of areas of a device, and the present embodiments are not limited thereto.

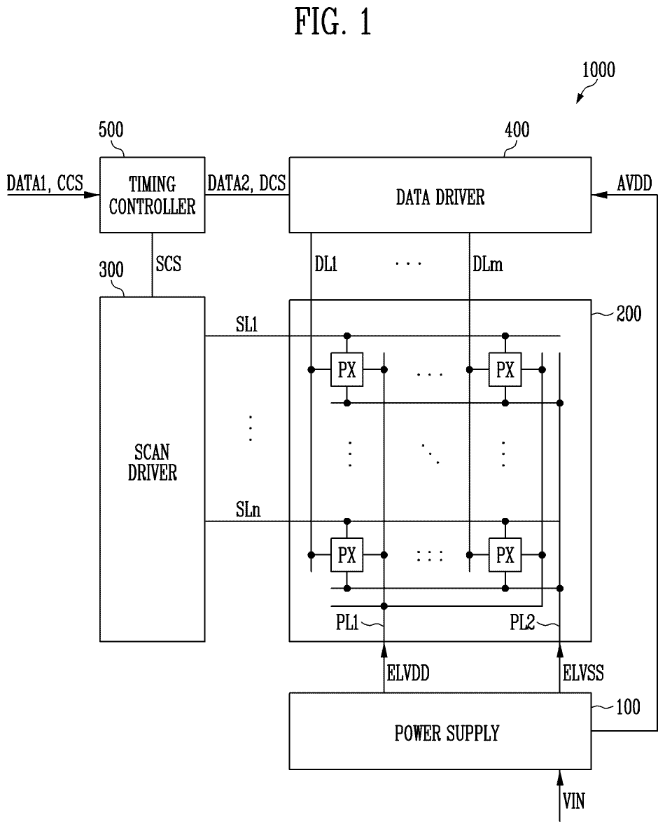

FIG. 1 is a block diagram illustrating a display device 1000 according to some embodiments of the present disclosure.

Referring to FIG. 1, the display device 1000 may include a display panel 200, a scan driver 300, a data driver 400, a timing controller 500, and a power supply 100 (or a power supply device).

The display panel 200 may include scan lines SL1 to SLn, where n is a positive integer, data lines DL1 to DLm, where m is a positive integer, and pixels PX.

In addition, the display panel 200 may include a first power supply line PL1 and a second power supply line PL2.

In the present invention, the type of the display panel 200 is not particularly limited. For example, the display panel 200 may be a self-luminous display panel. The display panel 200 may include a plurality of light emitting devices. For example, an organic light emitting diode may be selected as a light emitting device. In addition, an inorganic light emitting diode, such as a micro light emitting diode (LED) or a quantum dot light emitting diode may be selected as the light emitting device. In addition, the light emitting device may include a combination of an organic material and an inorganic material.

Alternatively, the display panel 200 may be a non-light emitting display panel such as a liquid crystal display (LCD) panel, an electro-phoretic display (EPD) panel, or an electro-wetting display (EWD) panel. When the display panel 200 is the non-light emitting display panel, the display device 1000 may further include a back-light unit for supplying light to the display panel 200.

The pixels PX may be arranged in areas (e.g., pixel areas) partitioned by the scan lines SL1 to SLn and the data lines DL1 to DLm.

The pixel PX may be connected to the first power supply line PL1, the second power supply line PL2, a corresponding one of the scan lines SL1 to SLn, and a corresponding one of the data lines DL1 to DLm. Hereinafter, “connect” includes not only electrical connections, but also physical connections, and may include indirect connections through other components as well as direct connections.

The pixel PX may include a light emitting device and at least one transistor which provides or is for providing a driving current to the light emitting device.

The pixel PX may emit light at a luminance corresponding to a data voltage (or a data signal) provided through a data line in response to a scan signal provided through a scan line. For example, the pixel PX located in an n-th row and an m-th column may emit light at a luminance corresponding to a data voltage (or a data signal) provided through the m-th data line DLm in response to a scan signal provided through the n-th scan line SLn.

The scan driver 300 may generate a scan signal based on a scan control signal SCS, and sequentially provide the scan signal to the scan lines SL1 to SLn. The scan control signal SCS includes a scan start signal (or a scan start pulse), scan clock signals, and the like, and may be provided from the timing controller 500. For example, the scan driver 300 may include a shift register which uses scan clock signals to sequentially generate and output a scan signal in the form of a pulse which corresponds to a scan start signal in the form of a pulse (e.g., a pulse at a gate-on voltage level).

The data driver 400 may generate data voltages (or data signals) based on image data DATA2 and a data control signal DCS provided from the timing controller 500, and may provide data voltages to the data lines DL1 to DLm. The data control signal DCS controls the operation of the data driver 400, and may include a load signal (or a data enable signal) which indicates the output of a valid data voltage.

For example, the data driver 400 may generate a data voltage corresponding to a data value (or a grayscale value) included in the image data DATA2 by using gamma voltages. The gamma voltages may be generated in the data driver 400 or provided from a separate gamma voltage generation circuit (e.g., a gamma integrated circuit). For example, the data driver 400 may select one of the gamma voltages based on the data value and may output the selected gamma voltage as a data signal.

The timing controller 500 may receive input image data DATA1 and a control signal CCS from the outside (e.g., an application processor), and may generate the scan control signal SCS and the data control signal DCS based on the control signal CCS. The control signal CCS may include a vertical synchronization signal, a horizontal synchronization signal, a clock signal, and the like. In addition, the timing controller 500 may generate the image data DATA2 by converting the input image data DATA1. For example, the timing controller 500 may convert the input image data DATA1 into the image data DATA2 having a format available in the data driver 400.

In FIG. 1, the scan driver 300, the data driver 400, and the timing controller 500 are illustrated as being configured independently of each other, but this is illustrative and not limited thereto. For example, at least one of the scan driver 300, the data driver 400, or the timing controller 500 may be formed on the display panel 200, or may be implemented in an IC and mounted on a flexible circuit board to be connected to the display panel 200. For example, the scan driver 300 may be formed on the display panel 200. In addition, at least two of the scan driver 300, the data driver 400, and the timing controller 500 may be implemented in one IC.

The power supply 100 (or the power supply device) according to some embodiments of the present disclosure may generate and supply a first power supply voltage ELVDD to the first power supply line PL1 by using an input power VIN, and may generate and supply a second power supply voltage ELVSS to the second power supply line PL2. The first power supply voltage ELVDD and the second power supply voltage ELVSS are applied to perform the operations of the pixel PX, and the first power supply voltage ELVDD may have a voltage level higher than a voltage level of the second power supply voltage ELVSS.

For example, the power supply 100 is implemented in a power management integrated circuit (PMIC) and may convert the input power VIN into the first power supply voltage ELVDD and the second power supply voltage ELVSS through a switching operation on transistors provided therein.

In addition, the power supply 100 may generate a third power supply voltage AVDD by using the input power VIN and provide the third power supply voltage AVDD to the data driver 400. The third power supply voltage AVDD is applied to drive the data driver 400 (e.g., generating the gamma voltages).

The power supply 100 may manage the magnitude and sequence of the source voltages (ELVDD, ELVSS, and AVDD) provided to the display panel 200 and the data driver 400 based on the input power VIN. For example, the first power supply voltage ELVDD and the second power supply voltage ELVSS may be a positive voltage and a negative voltage, respectively, for driving the pixels PX, and the third power supply voltage AVDD may be applied to drive the data driver 400.

According to some embodiments, in the power supply 100, a converter which converts a voltage of the input power VIN into the first power supply voltage ELVDD and a converter which converts a voltage of the input power VIN to the third power supply voltage AVDD may be a boost converter, and a converter which converts the voltage of the input power VIN into the second power supply voltage ELVSS may be a buck converter.

The power supply 100 may vary the voltage levels of the first power supply voltage ELVDD, the second power supply voltage ELVSS, and the third power supply voltage AVDD according to the luminance or the frame frequency of the display panel 200. The frame frequency may indicate how many images the display panel 200 can display per second.

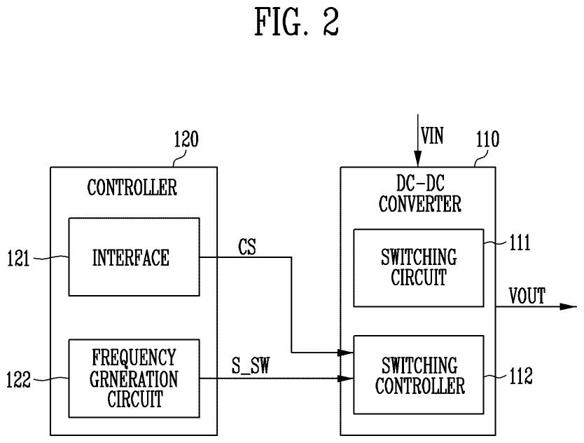

FIG. 2 is a block diagram illustrating aspects of the power supply 100 included in the display device of FIG. 1.

Referring to FIG. 2, the power supply 100 may include a DC-DC converter 110 and a controller 120.

The DC-DC converter 110 may include a switching circuit 111 and a switching controller 112 which controls an on/off operation of the switching circuit 111.

Referring to FIG. 1, the DC-DC converter 110 may convert the input power VIN into the first power supply voltage ELVDD, the second power supply voltage ELVSS, and the third power supply voltage AVDD.

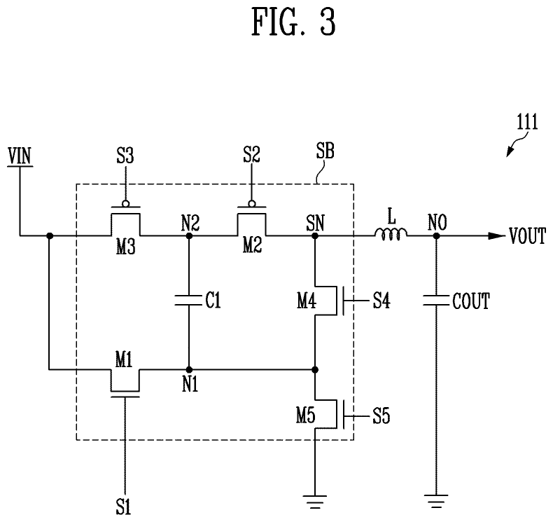

For example, the DC-DC converter 110 may boost a voltage level of the input power VIN to generate the first power supply voltage ELVDD or the third power supply voltage AVDD as an output power VOUT. In addition, the DC-DC converter 110 may generate the second power supply voltage ELVSS as the output power VOUT by lowering the voltage level of the input power VIN. The specific configuration of the DC-DC converter 110 will be described below with reference to FIG. 3.

The controller 120 may include an interface 121 which receives data from the outside, and a frequency generation circuit 122 which supplies a frequency signal S_SW to the switching controller 112.

The interface 121 may receive data for controlling the switching circuit 111 from the outside (for example, the timing controller 500 of FIG. 1) and may generate a control signal CS according to the received data.

The control signal CS may controls on duty ratios of signals which are output to the switching circuit 111 by the switching controller 112.

According to some embodiments, the interface 121 may perform communication in an inter-integrated circuit (I²C) manner. Such an I²C communication method may change functions in software without changing hardware, and may support one-to-many communication functions. The I²C interface may communicate using two wires: a serial data (SDA) wire and a serial clock (SCL) wire. However, the present disclosure is not limited thereto, and the interface 121 may perform data communication using various known interface methods.

The frequency generation circuit 122 may generate the frequency signal S_SW by using a reference clock signal received from the outside, and may supply the frequency signal to the DC-DC converter 110 (or the switching controller 112).

FIG. 2 illustrates a configuration for explaining aspects of some embodiments of the present disclosure, and the DC-DC converter 110 and the controller 120 may further include other configurations according to the operation of the power supply 100.

FIG. 3 is a block diagram illustrating aspects of the switching circuit 111 of FIG. 2 according to some embodiments. Although FIG. 3 illustrates various components in a switching circuit according to some embodiments, embodiments according to the present disclosure are not limited thereto, and according to various embodiments, the switching circuit may include additional components or fewer components without departing from the spirit and scope of embodiments according to the present disclosure.

Referring to FIG. 3, the switching circuit 111 may include a switching block SB, an inductor L, and an output capacitor COUT.

The switching circuit 111 may convert the input power VIN by the switching block SB and output one of the first to third power supply voltages as the output power VOUT.

The switching block SB may turn on/off first to fifth transistors M1 to M5 based on first to fifth control signals S1 to S5, respectively, thereby converting the input power VIN to a switching voltage. The switching voltage may be output by a switching node SN.

The switching block SB may be connected between an input node receiving the input power VIN and the switching node SN. The inductor L may be connected between the switching node SN and an output node NO. The output capacitor COUT may be connected between the output node NO and a ground node which receives ground power.

The switching block SB may include the first to fifth transistors M1 to M5, and a first capacitor C1.

Referring to FIG. 2, each of the first to fifth transistors M1 to M5 may be turned on or off based on a signal which is output from the switching controller 112.

Hereinafter, for convenience of description, the description will focus on the first transistor M1 being turned on when a first control signal S1 has a logic high level, and the second transistor M2 being turned on when a second control signal S2 has a logic high level.

The first transistor M1 may be connected between the input node providing the input power VIN and the first node N1. The first transistor M1 may include a gate electrode which receives the first control signal S1 output from the switching controller 112.

The second transistor M2 may be connected between a second node N2 and the switching node SN. The second transistor M2 may include a gate electrode which receives the second control signal S2 output from the switching controller 112.

The second control signal S2 may have a phase difference of 180° from the first control signal S1. That is, the second control signal S2 may be behind or ahead by half of one period of the first control signal S1.

The third transistor M3 may be connected between the input node providing the input power VIN and the second node N2. The third transistor M3 may include a gate electrode which receives the third control signal S3 output from the switching controller 112.

The third control signal S3 may control the third transistor M3 to be turned on or off alternately with the first transistor M1. For example, an interval during which the third transistor M3 is turned on does not overlap with an interval during which the first transistor M1 is turned on, and an interval during which the third transistor M3 is turned off does not overlap with an interval during which the first transistor M1 is turned off.

A fourth transistor M4 may be connected between the switching node SN and the first node N1. The fourth transistor M4 may include a gate electrode which receives a fourth control signal S4 output from the switching controller 112.

The fourth control signal S4 may control the fourth transistor M4 to be turned on or off alternately with the second transistor M2.

An interval during which the fourth transistor M4 is turned on does not overlap with an interval during which the second transistor M2 is turned on, and an interval during which the fourth semiconductor M4 is turned off does not overlap with an interval during which the second semiconductor M2 is turned off.

The fifth transistor M5 may be connected between the first node N1 and the ground node providing the ground power. The fifth transistor M5 may include a gate electrode which receives the fifth control signal S5 output from the switching controller 112.

The fifth control signal S5 may control the fifth transistor M5 to be turned on or off alternately with the first transistor M1. For example, an interval during which the fifth transistor M5 is turned on does not overlap with the interval during which the first transistor M1 is turned on, and an interval during which the fifth transistor M5 is turned off does not overlap with the interval during which the first transistor M1 is turned off.

The third transistor M3 and the fifth transistor M5 are controlled to be turned on or off alternately with the first transistor M1, and the fourth transistor M4 is controlled to be turned on or off alternately with the second transistor M2, so that the switching block SB may convert the input power VIN into a switching voltage by the transistors which are turned on/off based on the first control signal S1 which controls the first transistor M1 and the second control signal S2 which controls the second transistor M2.

The first capacitor C1 may be connected between the second node N2 and the first node N1.

Each of the first transistor M1, the fourth transistor M4, and the fifth transistor M5 may be an N-type transistor. Each of the second transistor M2 and the third transistor M3 may be a P-type transistor.

However, the present disclosure is not limited thereto. For example, each of the first transistor M1, the fourth transistor M4, and the fifth transistor M5 may be a P-type transistor, and each of the second transistor M2 and the third transistor M3 may be an N-type transistor.

In addition, although the switching block SB is illustrated in FIG. 3 as including the first to fifth transistors M1 to M5 and the first capacitor C1, the present disclosure is not limited thereto, and the switching block SB may be variously configured according to some embodiments.

When an on duty ratio D of each of the first control signal S1 and the second control signal S2 is greater than a reference value, the DC-DC converter 110 of FIG. 2 including the switching circuit 111 may operate as a boost converter. That is, when the on duty ratio D of each of the first control signal S1 and the second control signal S2 is greater than the reference value, a voltage level of the output power VOUT may be greater than that of the input power VIN.

When the on duty ratio D of each of the first control signal S1 and the second control signal S2 is less than or equal to the reference value, the DC-DC converter 110 may operate as a buck converter. That is, when the on duty ratio D of each of the first control signal S1 and the second control signal S2 is less than or equal to the reference value, the voltage level of the output power VOUT may be less than the voltage level of the input power VIN.

The third transistor M3 and the fifth transistor M5 in FIG. 3 are controlled to be turned on or off alternately with the first transistor M1, and the fourth transistor M4 is controlled to be turned on or off on alternately with the second transistor M2, so that the switching block SB may convert the input power VIN into a switching voltage by the transistors which are turned on/off based on the first control signal S1 which controls the first transistor M1 and the second control signal S2 which controls the second transistor M2.

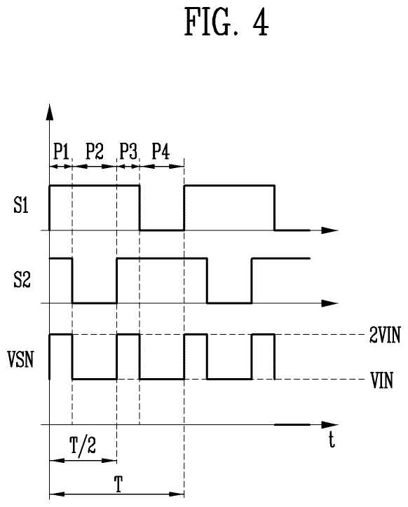

That is, as the operation of the switching block SB is controlled based on (or substantially based on) the two control signals, a phase difference between the first and second control signals S1 and S2 may be 180°, which is 360° divided by 2, and the reference value may be 0.5, which is 1 divided by 2. Hereinafter, the description will focus on the reference value of ‘0.5’ with reference to FIGS. 4 to 13.

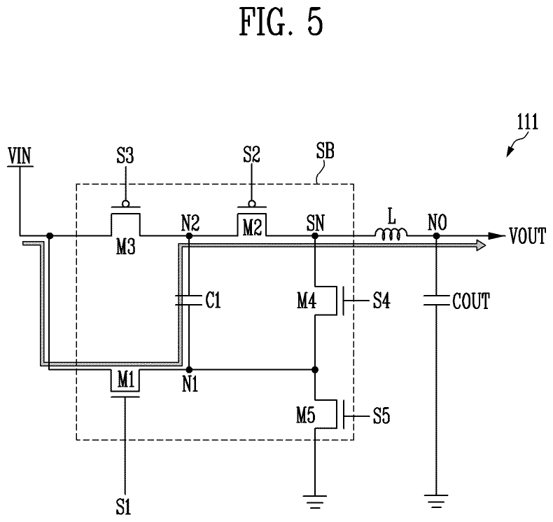

FIG. 4 is a timing diagram of the first control signal S1 and the second control signal S2 according to some embodiments. FIGS. 5 to 7 are circuit diagrams showing an operating process of the switching circuit according to the signals of FIG. 4.

Referring to FIG. 4, one switching cycle T may include first to fourth intervals P1 to P4. As described above with reference to FIG. 3, the second control signal S2 may have a phase difference of 180° from the first control signal S1. Accordingly, the second control signal S2 may be half (T/2) of the switching cycle T behind or ahead of the first control signal S1.

Further, the on duty ratio of each of the first and second control signals S1 and S2 of FIG. 4 may be greater than 0.5. Thus, during the switching cycle T, there may be no interval during which both the first and third control signals S1 and S3 have a logic low level.

Referring to FIGS. 4 and 5, during the first interval P1 and the third interval P3, each of the first control signal S1 and the second control signal S2 may have a logic high level. Accordingly, during the first interval P1 and the third interval P3, the first transistor M1 and the second transistor M2 may be turned on.

As the third transistor M3 and the fifth transistor M5 operate complementarily to the first transistor M1, the third transistor M3 and the fifth transistor M5 may be turned off.

As the fourth transistor M4 operates complementarily to the second transistor M2, the fourth transistor M4 may be turned off.

As the first transistor M1 and the second transistor M2 are turned on, the first capacitor C1 stored with the voltage of the input power VIN may be discharged. Accordingly, a switching voltage VSN may have twice the voltage level of the input power VIN.

Because the voltage level of the switching voltage VSN is greater than that of the output power VOUT, a current may flow from the switching node SN to the output node NO while charging the inductor L. A direct current (DC) voltage among the voltages of the output node NO may be output as the output power VOUT, and an alternating current (AC) voltage among the voltages of the output node NO may correspond to an output ripple.

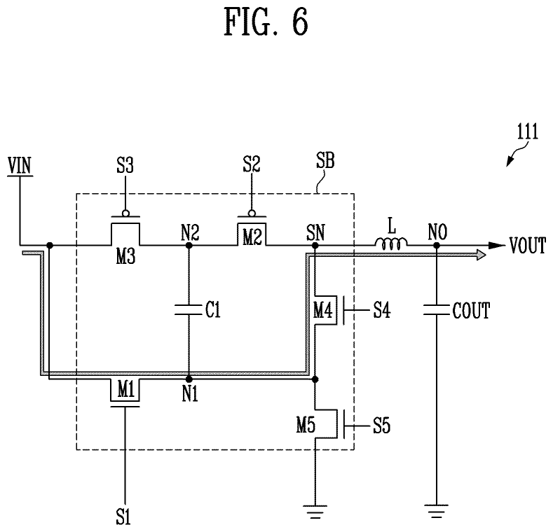

Referring to FIGS. 4 and 6, during the second interval P2 after the first interval P1, the first control signal S1 may have a logic high level and the second control signal S2 may have a logic low level. Accordingly, during the second interval P2, the first transistor M1 may be turned on and the second transistor M2 may be turned off.

As the third transistor M3 and the fifth transistor M5 operate complementarily to the first transistor M1, the third transistor M3 and the fifth transistor M5 may be turned off.

As the fourth transistor M4 operates complementarily to the second transistor M2, the fourth transistor M4 may be turned on.

As the second and third transistors M2 and M3 are turned off, the first capacitor C1 may be floated with the voltage of the input power VIN stored therein. The switching voltage VSN may become smaller than the output power VOUT. As a result, the inductor L may be discharged.

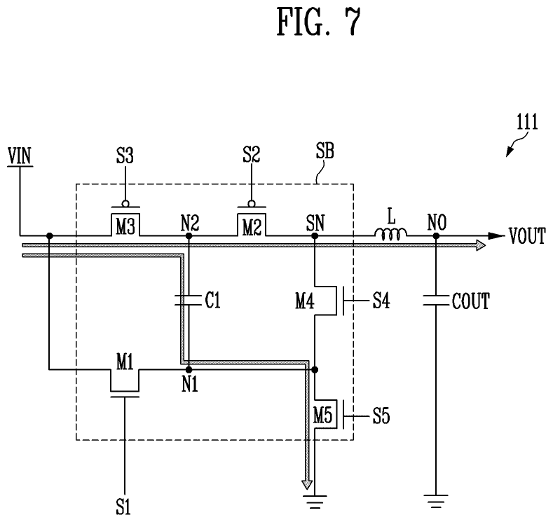

Referring to FIGS. 4 and 7, during the fourth interval P4 after the third interval P3, the first control signal S1 may have a logic low level and the second control signal S2 may have a logic high level. Accordingly, during the fourth interval P4, the first transistor M1 may be turned off and the second transistor M2 may be turned on.

As the third transistor M3 and the fifth transistor M5 operate complementarily to the first transistor M1, the third transistor M3 and the fifth transistor M5 may be turned on.

As the fourth transistor M4 operates complementarily to the second transistor M2, the fourth transistor M4 may be turned off.

As the third and fifth transistors M3 and M5 are turned on, the first capacitor C1 discharged during the third interval P3 may be charged back to the voltage of the input power VIN. Further, as the second and third transistors M2 and M3 are turned on, the switching voltage VSN may have the voltage of the input power VIN.

Similarly to the second interval P2, the switching voltage VSN becomes smaller than the output power VOUT. As a result, the inductor L may be discharged.

As the switching cycle T including the first to fourth intervals P1 to P4 is repeated, the DC-DC converter including the switching circuit 111 of FIG. 3 operating in response to the signals of FIG. 4 may operate as a boost converter.

In addition, the voltage level of the switching voltage VSN may be between the voltage level of the input power VIN and twice the voltage level of the input power VIN. That is, a voltage conversion ratio of the DC-DC converter 110 including the switching circuit 111 of FIG. 3 operating according to the signals of FIG. 4 may be greater than one and less than two.

As shown in FIG. 4, an amplitude of the switching voltage VSN is the same as the voltage level of the input power VIN. Thus, an output ripple may be small.

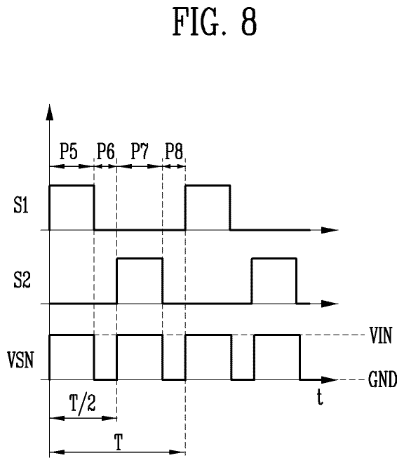

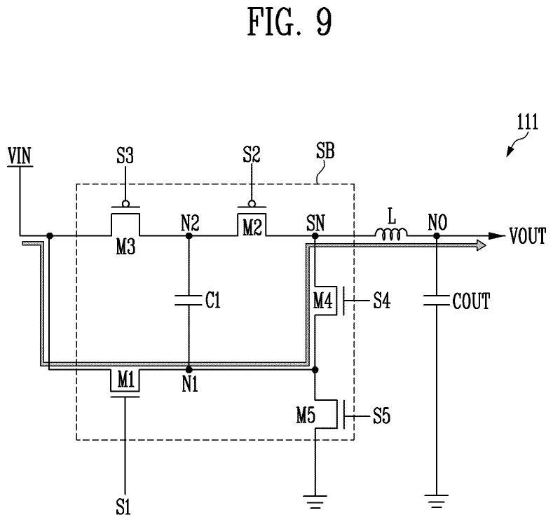

FIG. 8 is a timing diagram of the first control signal S1 and the second control signal S2 according to some embodiments. FIGS. 9 to 11 are circuit diagrams showing an operating process of the switching circuit in response to the signals of FIG. 8.

Referring to FIG. 8, one switching cycle T may include fifth to eighth intervals P5 to P8. As described above with reference to FIG. 3, the second control signal S2 may have a phase difference of 180° from the first control signal S1. Accordingly, the second control signal S2 may be half (T/2) of the switching cycle T2 behind or ahead of the first control signal S1.

Further, the on duty ratio of each of the first and second control signals S1 and S2 as shown in FIG. 8 may be less than or equal to 0.5. Thus, during the switching cycle T, there may be no interval during which both the first and second control signals S1 and S2 have a logic high level.

Referring to FIGS. 8 and 9, during the fifth interval P5, the first control signal S1 may have a logic high level and the second control signal S2 may have a logic low level. Accordingly, during the fifth interval P5, the first transistor M1 may be turned on and the second transistor M2 may be turned off.

As the third transistor M3 and the fifth transistor M5 operate complementarily to the first transistor M1, the third transistor M3 and the fifth transistor M5 may be turned off.

As the fourth transistor M4 operates complementarily to the second transistor M2, the fourth transistor M4 may be turned on. Further, as the second and third transistors M2 and M3 are turned off, the first capacitor C1 may be floated with the voltage of the input power VIN stored therein.

As the voltage level of the switching voltage VSN is greater than that of the output power VOUT, a current may flow from the switching node SN to the output node NO while charging the inductor L.

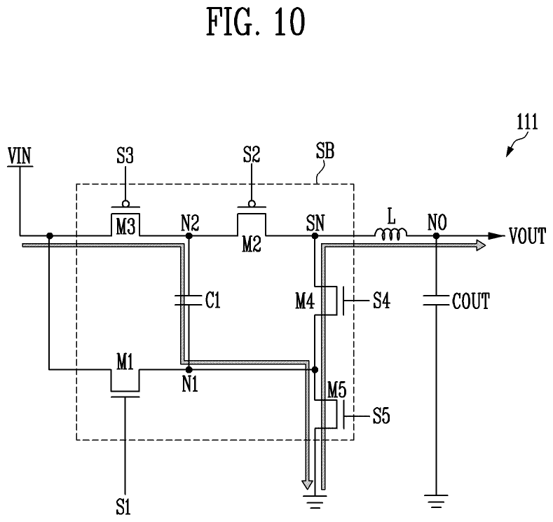

Referring to FIGS. 8 and 10, during a sixth interval P6 after the fifth interval P5 and the eighth interval P8 after a seventh interval P7, the first control signal S1 and the second control signal S2 each may have a logic low level. Accordingly, during the sixth interval P6 and the eighth interval P8, the first transistor M1 and the second transistor M2 may be turned off.

As the third transistor M3 and the fifth transistor M5 operate complementarily to the first transistor M1, the third transistor M3 and the fifth transistor M5 may be turned on.

As the fourth transistor M4 operates complementarily to the second transistor M2, the fourth transistor M4 may be turned on.

As the third and fifth transistors M3 and M5 are turned on, the first capacitor C1 stores the voltage of the input power VIN, and as the fourth and fifth transistors M4 and M5 are turned on, the switching voltage VSN may have a ground voltage GND.

The switching voltage VSN becomes smaller than the output power VOUT. As a result, the inductor L may be discharged.

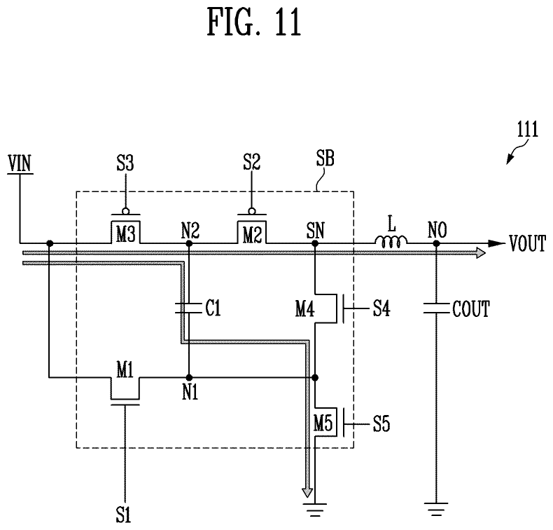

Referring to FIGS. 8 and 11, during the seventh interval P7 after the sixth interval P6, the first control signal S1 may have a logic low level and the second control signal S2 may have a logic high level. Accordingly, during the seventh interval P7, the first transistor M1 may be turned off and the second transistor M2 may be turned on.

As the third transistor M3 and the fifth transistor M5 operate complementarily to the first transistor M1, the third transistor M3 and the fifth transistor M5 may be turned on.

As the fourth transistor M4 operates complementarily to the second transistor M2, the fourth transistor M4 may be turned off.

As the third and fifth transistors M3 and M5 are turned on, the first capacitor C1 discharged during the sixth interval P6 may be charged back to the voltage of the input power VIN. Further, as the second and third transistors M2 and M3 are turned on, the switching voltage VSN may have the voltage of the input power VIN.

Similarly to the fifth interval P5, the voltage level of the switching voltage VSN is greater than that of the output power VOUT, so that the inductor L may be charged and a current may flow from the switching node SN to the output node NO.

As the switching cycle T including the fifth to eighth intervals P5 to P8 is repeated, the DC-DC converter including the switching circuit 111 of FIG. 3 operating according to the signals of FIG. 8 may operate as a buck converter.

In addition, the voltage level of the switching voltage VSN may be between a voltage level of the ground voltage GND and the voltage level of the input power VIN. That is, the voltage conversion ratio of the DC-DC converter 110 including the switching circuit 111 of FIG. 3 operating according to the signals of FIG. 8 may be greater than zero and less than or equal to 1.

As shown in FIG. 8, because the amplitude of the switching voltage VSN is the same as the voltage level of the input power VIN, the output ripple may be small.

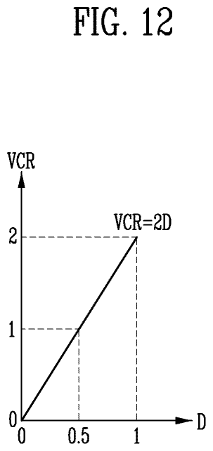

FIG. 12 is a graph showing a voltage conversion ratio VCR of the DC-DC converter according to some embodiments of the present disclosure.

Referring to FIGS. 4, 8, and 12, the horizontal axis represents the on duty ratio D of each of the first control signal S1 and the second control signal S2, and the vertical axis represents the voltage conversion ratio VCR.

As the on duty ratio D of each of the first control signal S1 and the second control signal S2 increases, the voltage conversion ratio VCR may increase. Referring to the interval during which the on duty ratio D is greater than zero and less than or equal to 0.5, the voltage conversion ratio VCR may be greater than zero and smaller than or equal to one. That is, the switching voltage VSN may have a voltage level between the voltage level of the ground power and the voltage level of the input power VIN.

Referring to the interval during which the on duty ratio D is greater than 0.5 and less than or equal to one, the voltage conversion ratio VCR may be greater than one and less than or equal to two. That is, the switching voltage VSN may have a voltage level between the voltage level of the input power VIN and twice the voltage level of the input power VIN.

Accordingly, as the on duty ratio D increases from zero to one, the voltage levels of the switching voltage VSN and the output power VOUT may continuously increase. For example, as the on duty ratio D increases from zero to one, the voltage level of the switching voltage VSN may continuously increase from the voltage level of the ground power to twice the voltage level of the input power VIN. That is, by controlling the on duty ratio D, the voltage conversion ratio VCR of the DC-DC converter 110 may be controlled.

In addition, as the on duty ratio D is proportional to the voltage conversion ratio VCR without any discontinuous interval, by controlling the on duty ratio D, the DC-DC converter 110 may smoothly switch modes between the boost converter and the buck converter.

As the output ripple is low and the mode switching between the boost converter and the buck converter is smooth, flicker visibility prevention and image quality of the display panel 200 may be relatively improved.

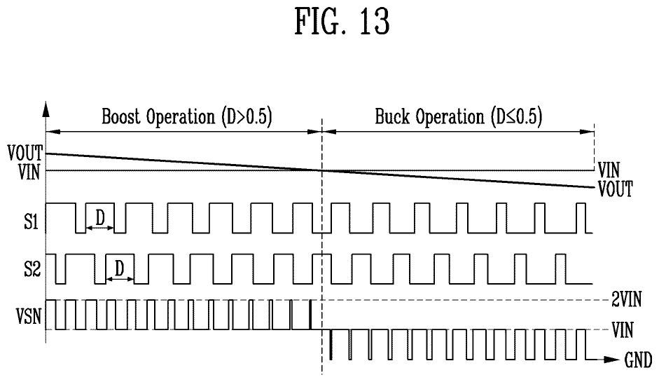

FIG. 13 is a graph showing the on duty ratio D and the output power VOUT according to some embodiments of the present disclosure.

Referring to FIG. 13, the output power VOUT according to the on duty ratio D of each of the first control signal S1 and the second control signal S2 applied to the switching circuit 111 of FIG. 3 is shown.

When the on duty ratio D of each of the first control signal S1 and the second control signal S2 is greater than the reference value, the DC-DC converter 110 of FIG. 2 including the switching circuit 111 may operate as a boost converter. That is, when the on duty ratio D of each of the first control signal S1 and the second control signal S2 is greater than the reference value, the voltage level of the output power VOUT may be greater than the voltage level of the input power VIN.

On the other hand, when the on duty ratio D of each of the first control signal S1 and the second control signal S2 is less than or equal to the reference value, the DC-DC converter 110 may operate as a buck converter. That is, when the on duty ratio D of each of the first control signal S1 and the second control signal S2 is less than or equal to the reference value, the voltage level of the output power VOUT may be less than that of the input power VIN.

Referring to FIG. 13, as the on duty ratio D decreases from one to zero, the voltage level of the output power VOUT may continuously decrease.

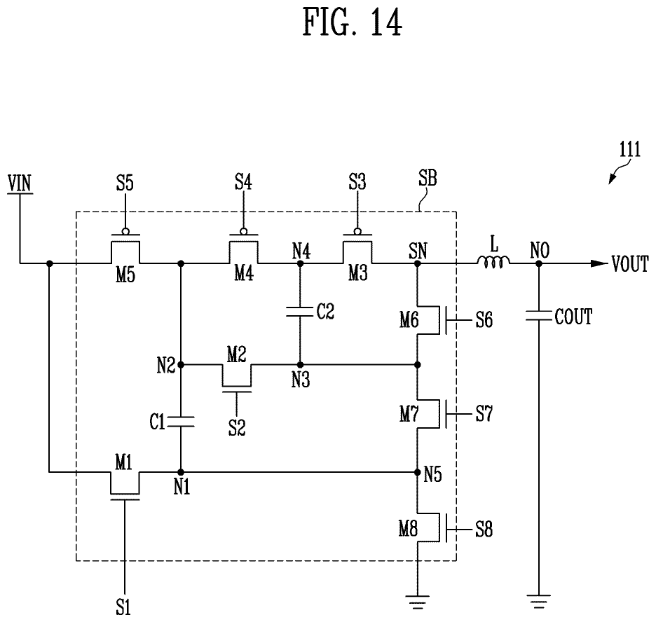

FIG. 14 is a block diagram illustrating aspects of the switching circuit 111 of FIG. 2 according to some embodiments. Although FIG. 14 illustrates various components in a switching circuit according to some embodiments, embodiments according to the present disclosure are not limited thereto, and according to various embodiments, the switching circuit may include additional components or fewer components without departing from the spirit and scope of embodiments according to the present disclosure.

Referring to FIG. 14, the switching circuit 111 may include the switching block SB, the inductor L, and the output capacitor COUT.

Because the switching circuit 111 of FIG. 14 is similar to the switching circuit 111 in FIG. 3, overlapping descriptions thereof may be omitted accordingly.

The switching circuit 111 may convert the input power VIN by the switching block SB and output one of the first to third power supply voltages as the output power VOUT.

The switching block SB may turn on/off first to eighth transistors M1 to M8 based on first to eighth control signals S1 to S8, thereby converting the input power VIN into a switching voltage.

The switching block SB may be connected between the input node receiving the input power VIN and the switching node SN. The inductor L may be connected between the switching node SN and the output node NO. The output capacitor COUT may be connected between the output node NO and the ground node which receives the ground power.

The switching block SB may include the first to eighth transistors M1 to M8, the first capacitor C1, and a second capacitor C2.

Referring to FIG. 2, each of the first to eighth transistors M1 to M8 may be turned on or off based on signals output from the switching controller 112.

Hereinafter, for convenience of description, the description will focus on the first transistor M1 being turned on when the first control signal S1 has a logic high level, the second transistor M2 being turned on when the second control signal S2 has a logic high level, and the third transistor M3 being turned on when third control signal S3 has a logic high level.

In addition, the description will focus on the first transistor M1 being turned off when the first control signal S1 has a logic low level, the second transistor M2 being turned off when the second control signal S2 has a logic high level, and the third transistor M3 being turned off when third control signal S3 has a logic low level.

The first transistor M1 may be connected between the input node providing the input power VIN and the first node N1. The first transistor M1 may include a gate electrode which receives the first control signal S1 output from the switching controller 112.

The second transistor M2 may be connected between the second node N2 and the third node N3. The second transistor M2 may include a gate electrode which receives the second control signal S2 output from the switching controller 112.

The second control signal S2 may have a phase difference of 120° from the first control signal S1. For example, the second control signal S2 may be 120° behind the first control signal S1.

The third transistor M3 may be connected between a fourth node N4 and the switching node SN. The third transistor M3 may include a gate electrode which receives the third control signal S3 output from the switching controller 112.

The third control signal S3 may have a phase difference of 240° from the first control signal S1. For example, the third control signal S3 may be 240° behind the first control signal S1.

The fourth transistor M4 may be connected between the second node N2 and the fourth node N4. The fourth transistor M4 may include a gate electrode which receives the fourth control signal S4 output from the switching controller 112.

The fourth control signal S4 may control the fourth transistor M4 to be turned on or off alternately with the second transistor M2. For example, an interval during which the fourth transistor M4 is turned on does not overlap with an interval during which the second transistor M2 is turned on, and an interval during which the third transistor M4 is turned off does not overlap with an interval during which the second transistor M2 is turned off.

The fifth transistor M5 may be connected between the input node and the second node N2. The fifth transistor M5 may include a gate electrode which receives the fifth control signal S5 output from the switching controller 112.

The fifth control signal S5 may control the fifth transistor M5 to be turned on or off alternately with the first transistor M1. For example, an interval during which the fifth transistor M5 is turned on does not overlap with an interval during which the first transistor M1 is turned on, and an interval during which the fifth transistor M5 is turned off does not overlap with an interval during which the first transistor M1 is turned off.

The sixth transistor M6 may be connected between the switching node SN and the third node N3. The sixth transistor M6 may include a gate electrode which receives a sixth control signal S6 output from the switching controller 112.

The sixth control signal S6 may control the sixth transistor M6 to be turned on or off alternately with the third transistor M3. For example, an interval during which the sixth transistor M6 is turned on does not overlap with an interval during which the third transistor M3 is turned on, and an interval during which the fifth transistor M6 is turned off does not overlap with the interval during which the third transistor M3 is turned off.

The seventh transistor M7 may be connected between the third node N3 and the fifth node N5. The seventh transistor M7 may include a gate electrode which receives a seventh control signal S7 output from the switching controller 112.

The seventh control signal S7 may control the seventh transistor M7 to be turned on or off alternately with the second transistor M2. For example, an interval during which the seventh transistor M7 is turned on does not overlap with an interval during which the second transistor M2 is turned on, and an interval during which the seventh transistor M7 is turned off does not overlap with the interval during which the second transistor M2 is turned off.

The eighth transistor M8 may be connected between the fifth node N5 and the ground node. The eighth transistor M8 may include a gate electrode which receives the eighth control signal S8 output from the switching controller 112.

The eighth control signal S8 may control the eighth transistor M8 to be turned on or off alternately with the first transistor M1. For example, an interval during which the eighth transistor M8 is turned on does not overlap with the interval during which the first transistor M1 is turned on, and an interval during which the eighth transistor M8 is turned off does not overlap with the interval during which the first transistor M1 is turned off.

The first capacitor C1 may be connected between the first node N1 and the second node N2. The second capacitor C2 may be connected between the third node N3 and the fourth node N4.

Each of the first transistor M1, the second transistor M2, the sixth transistor M6, the seventh transistor M7, and the eighth transistor M8 may be an N-type transistor. Each of the third transistor M3, the fourth transistor M4, and the fifth transistor M5 may be a P-type transistor.

Although the switching block SB is illustrated in FIG. 14 as including the first to eighth transistors M1 to M8, the first capacitor C1, and the second capacitor C2, the present disclosure is not limited thereto, and the switching block SB may be variously configured according to some embodiments.

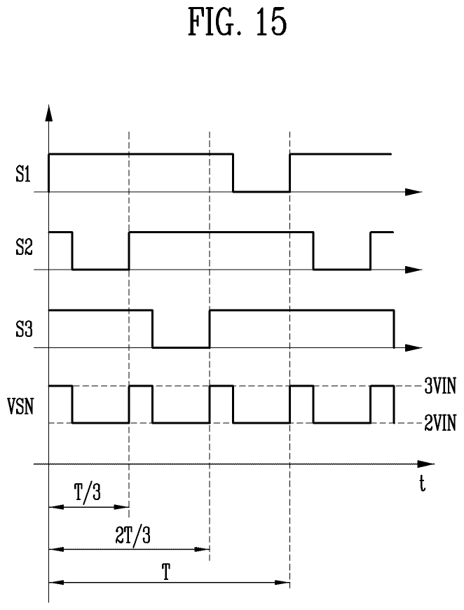

FIGS. 15 to 17 are timing diagrams of the first control signal S1, the second control signal S2, and the third control signal S3 according to some embodiments.

Referring to FIG. 15, the on duty ratio of each of the first to third control signals S1 to S3 may be greater than 2/3. When the switching block SB of FIG. 14 operates according to the signals of FIG. 15, the voltage level of the switching voltage VSN may be between twice the voltage level of the input power VIN and three times the voltage level of the input power VIN.

That is, the voltage conversion ratio of the DC-DC converter 110 including the switching circuit 111 of FIG. 14 operating according to the signals of FIG. 15 may be greater that two and less that three.

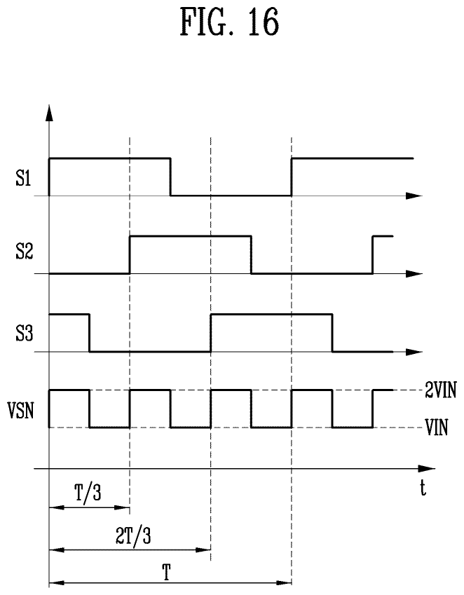

Referring to FIG. 16, the on duty ratio of each of the first to third control signals S1 to S3 may be greater than ⅓ and less than or equal to ⅔. When the switching block SB of FIG. 14 operates according to the signals of FIG. 16, the voltage level of the switching voltage VSN may be between the voltage level of the input power VIN and twice the voltage level of the input power VIN.

That is, the voltage conversion ratio of the DC-DC converter 110 including the switching circuit 111 of FIG. 14 operating according to the signals of FIG. 16 may be greater than one and less than two.

Accordingly, the DC-DC converter 110 including the switching circuit 111 of FIG. 14 operating in accordance with the signals of FIGS. 15 and 16 may operate as a boost converter.

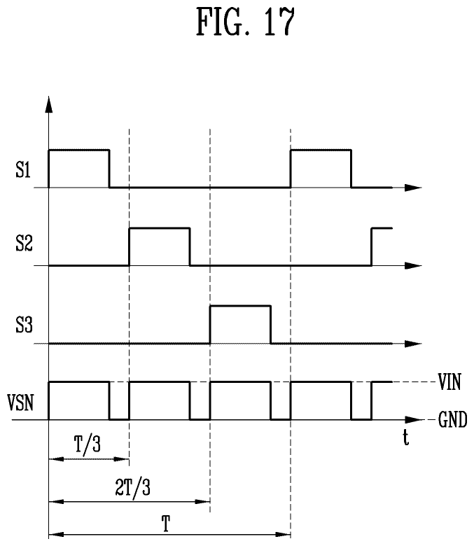

Referring to FIG. 17, the on duty ratio of each of the first to third control signals S1 to S3 may be less than or equal to ⅓. When the switching block SB of FIG. 14 operates according to the signals of FIG. 17, the voltage level of the switching voltage VSN may be between the voltage level of the ground power and the voltage level of the input power VIN.

That is, the voltage conversion ratio of the DC-DC converter 110 including the switching circuit 111 of FIG. 14 operating according to the signals of FIG. 17 may be greater than zero and less than or equal to one.

Accordingly, the DC-DC converter 110 including the switching circuit 111 of FIG. 14 operating in accordance with the signals of FIG. 17 may operate as a buck converter.

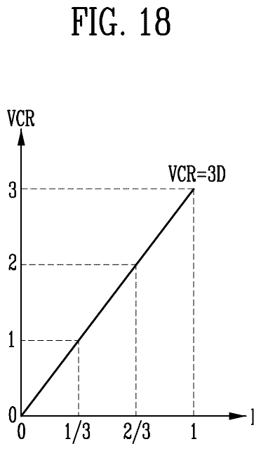

FIG. 18 is a graph showing the voltage conversion ratio VCR of the DC-DC converter according to some embodiments of the present disclosure.

Referring to FIG. 18, the horizontal axis represents the on duty ratio D of each of the first control signal S1, the second control signal S2, and the third control signal S3, and the vertical axis represents the voltage conversion ratio VCR.

As the on duty ratio D of each of the first control signal S1, the second control signal S2, and the third control signal S3 increases, the voltage conversion ratio VCR may increase. Referring to the interval during which the on duty ratio D is greater than zero and less than or equal to ⅓, the voltage conversion ratio VCR may be greater than zero and smaller than or equal to one. That is, the switching voltage VSN may have a voltage level between the voltage level of the ground power and the voltage level of the input power VIN.

Referring to the interval during which the on duty ratio D is greater than ⅓ and less than or equal to ⅔, the voltage conversion ratio VCR may be greater than one and less than or equal to two. That is, the switching voltage VSN may have a voltage level between the voltage level of the input power VIN and twice the voltage level of the input power VIN.

Referring to the interval during which the on duty ratio D is greater than ⅔ and less than or equal to one, the voltage conversion ratio VCR may be greater that two and less than or equal to three. That is, the switching voltage VSN may have a voltage level between twice the voltage level of the input power VIN and three times the voltage level of the input power VIN.

Accordingly, as the on duty ratio D increases from zero to one, the switching voltage VSN and the voltage level of the output power may continuously increase. For example, as the on duty ratio D increases from zero to one, the voltage level of the switching voltage VSN may continuously increase from the voltage level of the ground power to three times the voltage level of the input power VIN. That is, by controlling the on duty ratio D, the voltage conversion ratio VCR of the DC-DC converter 110 may be controlled.

In addition, as the on duty ratio D is proportional to the voltage conversion ratio VCR without any discontinuous interval, by controlling the on duty ratio D, the DC-DC converter 110 may smoothly switch modes between the boost converter and the buck converter.

As the output ripple is low and the mode switching between the boost converter and the buck converter is smooth, flicker visibility prevention and image quality of the display panel 200 may be relatively improved.

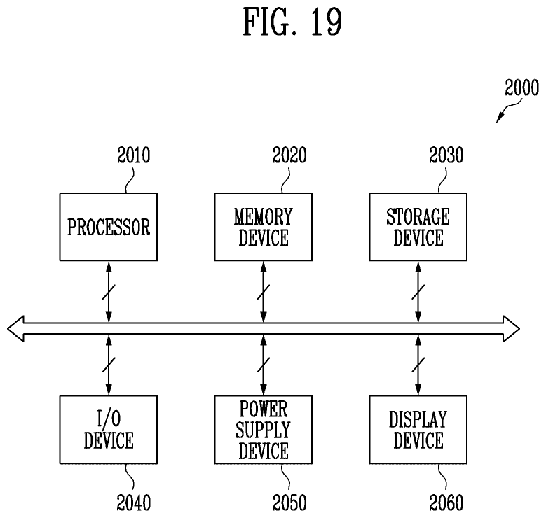

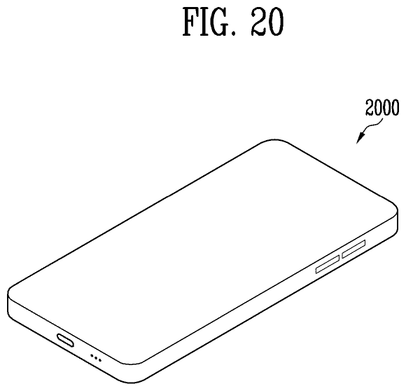

FIG. 19 is a block diagram illustrating an electronic device 2000 according to some embodiments of the present disclosure. FIG. 20 is a diagram illustrating an example in which the electronic device 2000 of FIG. 19 is a smartphone.

Referring to FIGS. 19 and 20, the electronic device 2000 may include a processor 2010, a memory device 2020, a storage device 2030, an input/output (I/O) device 2040, a power supply device 2050, and a display device 2060. The display device 2060 may be the display device 1000 of FIG. 1. The electronic device 2000 may further include various ports for communication with a video card, a sound card, a memory card, a USB device, or other systems. According to some embodiments, as illustrated in FIG. 20, the electronic device 2000 may be a smartphone. According to some embodiments, as illustrated in FIG. 20, the electronic device 2000 may be a tablet computer. However, this example is illustrative, and the electronic device 2000 is not necessarily limited to the aforementioned examples. For example, the electronic device 2000 may be a cellular phone, a video phone, a smart pad, a smartwatch, a navigation device for vehicles, a computer monitor, a laptop computer, a head-mounted display device, or the like.

The processor 2010 may perform specific calculations or tasks. According to some embodiments, the processor 2010 may be a microprocessor, a central processing unit, an application processor, or the like. The processor 2010 may be connected to other components through an address bus, a control bus, a data bus, and the like. According to some embodiments, the processor 2010 may be connected to an expansion bus such as a peripheral component interconnect (PCI) bus.

Referring to FIG. 1, the processor 2010 may generate input image data IMG and a signal CTRL for controlling the display thereof.

The memory device 2020 may store data needed to perform the operation of the electronic device 2000. For example, the memory device 2020 may include non-volatile memory devices such as an Erasable Programmable Read-Only Memory (EPROM) device, an Electrically Erasable Programmable Read-Only Memory (EEPROM) device, a flash memory device, a Phase Change Random Access Memory (PRAM) device, a Resistance Random Access Memory (RRAM) device, a Nano Floating Gate Memory (NFGM) device, a Polymer Random Access Memory (PoRAM) device, a Magnetic Random Access Memory (MRAM), and a Ferroelectric Random Access Memory (FRAM) device, and/or a volatile memory device such as a Dynamic Random Access Memory (DRAM) device, a Static Random Access Memory (SRAM) device, and a mobile DRAM device.

The storage device 2030 may include a solid state drive (SSD), a hard disk drive (HDD), a CD-ROM, or the like.

The I/O device 2040 may include input devices such as a keyboard, a keypad, a touchpad, a touch screen, and a mouse, and output devices such as a speaker and a printer. According to some embodiments, the display device 2060 may be included in the I/O device 2040.

The power supply device 2050 may supply power needed to perform the operation of the electronic device 2000. For example, the power supply device 2050 may include a power management integrated circuit (PMIC).

According to some embodiments, some components of the power supply device 2050 may be arranged inside the display device 2060, while other components of the power source device 2050 may be located outside the display device 2060.

According to some embodiments, the power supply device 2050 may be located outside the display device 2060. However, the present disclosure is not limited thereto. The power supply device 2050 may be connected to the processor 2010, the display device 2060, and the like to supply power.

The display device 2060 may display an image corresponding to visual information of the display device 2000. The display device 2060 may be an organic light emitting display device or a quantum dot light emitting display device, but the present disclosure is not limited to these. The display device 2060 may be the display device 1000 of FIG. 1.

In a power supply device, a display device including the power supply device, and an electronic device including the display device according to some embodiments of the present disclosure, mode switching between a boost converter and a buck converter may be relatively smooth, and an output ripple may be relatively low to thereby preventing or reducing flicker visibility.

The embodiments described above are provided to explain the present disclosure, but these embodiments are not intended to limit the scope of the present disclosure. It will be understood by those skilled in the art that various changes, substitutions, and alternatives may be made therein without departing from the scope of the disclosure as set forth by the claims and their equivalents. Therefore, the technical scope of the present disclosure may be determined based on the scope of the accompanying claims and their functional equivalents.

What is claimed is:

1. A power supply device comprising:
a switching block connected between an input node configured to receive an input power and a switching node configured to output a switching voltage, the switching block being configured to convert the input power into the switching voltage by transistors being turned on/off based on a first control signal and a second control signal;
an inductor connected between the switching node and an output node configured to output an output power; and
an output capacitor connected between the output node and a ground node configured to receive a ground power,
wherein based on an on duty ratio of each of the first control signal and the second control signal being greater than a reference value, a voltage level of the output power is greater than a voltage level of the input power, and based on the on duty ratio being less than or equal to the reference value, the voltage level of the output power is less than the voltage level of the input power.

2. The power supply device of claim 1, wherein based on the on duty ratio being greater than the reference value, the switching voltage has a voltage level between the voltage level of the input power and twice the voltage level of the input power, and
wherein based on the on duty ratio being less than or equal to the reference value, the switching voltage has the voltage level between a voltage level of the ground power and the voltage level of the input power.

3. The power supply device of claim 2, wherein as the on duty ratio increases from zero to one, the voltage level of the output power continuously increases from the voltage level of the ground power to twice the voltage level of the input power.

4. The power supply device of claim 3, wherein a phase difference between the first control signal and the second control signal is 180 degrees.

5. The power supply device of claim 4, wherein the reference value is 0.5.

6. The power supply device of claim 4, wherein the switching block comprises:
a first transistor coupled between the input node and a first node, the first transistor including a gate electrode receiving the first control signal;
a first capacitor connected between the first node and a second node;
a second transistor connected between the second node and the switching node, the second transistor including a gate electrode receiving the second control signal;
a third transistor coupled between the second node and the input node, the third transistor including a gate electrode receiving a third control signal;
a fourth transistor connected between the switching node and the first node, the fourth transistor including a gate electrode receiving a fourth control signal; and
a fifth transistor coupled between the first node and the ground node, the fifth transistor including a gate electrode receiving a fifth control signal.

7. The power supply device of claim 6, wherein based on the first control signal having a logic high level, the first transistor is configured to be turned on, and
wherein based on the second control signal has a logic high level, the second transistor is configured to be turned on.

8. The power supply device of claim 7, wherein the third control signal controls the third transistor to be turned on or off alternately with the first transistor,
wherein the fourth control signal controls the fourth transistor to be turned on or off alternately with the second transistor, and
wherein the fifth control signal controls the fifth transistor to be turned on or off alternately with the first transistor.

9. The power supply device of claim 7, wherein based on the on duty ratio being greater than the reference value, a switching cycle includes first to fourth consecutive intervals, and
wherein during the first interval and the third interval, the first transistor and the second transistor are configured to be turned on, the third transistor, the fourth transistor, and the fifth transistor are configured to be turned off, and the switching voltage is twice the voltage level of the input power.

10. The power supply device of claim 9, wherein during the second interval after the first interval:
the first transistor and the fourth transistor are configured to be turned on;
the second transistor, the third transistor, and the fifth transistor are configured to be turned off; and
the switching voltage has the voltage level of the input power.

11. The power supply device of claim 10, wherein during a fourth interval after a third interval:
the second transistor, the third transistor, and the fifth transistor are configured to be turned on; the first transistor and the fourth transistor are configured to be turned off; and
the switching voltage has the voltage level of the input power.

12. The power supply device of claim 11, wherein based on the on duty ratio being less than or equal to the reference value, the switching cycle includes fifth to eighth consecutive intervals, and
wherein during the fifth interval:
the first transistor and the fourth transistor are configured to be turned on;
the second transistor, the third transistor, and the fifth transistor configured to be turned off; and
the switching voltage has the voltage level of the input power.

13. The power supply device of claim 12, wherein during a sixth interval after the fifth interval and the eighth interval after a seventh interval:
the third transistor, the fourth transistor, and the fifth transistor are configured to be turned on;
the first transistor and the second transistor are configured to be turned off; and
the switching voltage has the voltage level of the ground power.

14. The power supply device of claim 13, wherein during the seventh interval after the sixth interval:
the second transistor, the third transistor, and the fifth transistor are configured to be turned on;
the first transistor and the fourth transistor are configured to be turned off; and
the switching voltage has the voltage level of the input power.

15. A display device, comprising:
a display panel including scan lines, a first power supply line, a second power supply line, and pixels connected to the scan lines and the first and second power supply lines;
a scan driver configured to sequentially provide scan signals to the scan lines; and
a power supply configured to convert an input power into a first power supply voltage and a second power supply voltage, to supply the first power supply voltage to the first power supply line, and to supply the second power supply voltage to the second power supply line,
wherein the power supply comprises:
a switching block connected between an input node configured to receive the input power and a switching node configured to output a switching voltage, the switching block being configured to convert the input power into the switching voltage by transistors being turned on/off based on a first control signal and a second control signal;
an inductor connected between the switching node and an output node outputting an output power; and
an output capacitor connected between the output node and a ground node receiving a ground power, and
wherein based on an on duty ratio of each of the first control signal and the second control signal being greater than a reference value, a voltage level of the output power is greater than a voltage level of the input power, and based on the on duty ratio being less than or equal to the reference value, the voltage level of the output power is less than the voltage level of the input power.

16. The display device of claim 15, wherein based on the on duty ratio being greater than the reference value, the switching voltage has a voltage level between the voltage level of the input power and twice the voltage level of the input power, and
wherein based on the on duty ratio being less than or equal to the reference value, the switching voltage has the voltage level between a voltage level of the ground power and the voltage level of the input power.

17. The display device of claim 16, wherein as the on duty ratio increases from zero to one, the voltage level of the output power continuously increases from the voltage level of the ground power to twice the voltage level of the input power.

18. The display device of claim 17, wherein the reference value is 0.5.

19. An electronic device, comprising:
a processor; and
a display device including pixels, the display device configured to display an image on the pixels in response to control of the processor,
wherein the display device comprises:
a display panel comprising scan lines, a first power supply line, a second power supply line, and the pixels connected to the scan lines, the first power supply line, and the second power supply line;
a scan driver configured to sequentially provide scan signals to the scan lines; and
a power supply configured to convert an input power into a first power supply voltage and a second power supply voltage, to supply the first power supply voltage to the first power supply line, and to supply the second power supply voltage to the second power supply line,
wherein the power supply comprises:
a switching block connected between an input node configured to receive the input power and a switching node configured to output a switching voltage, the switching block being configured to convert the input power to the switching voltage by transistors being turned on/off based on a first control signal and a second control signal;
an inductor connected between the switching node and an output node configured to output an output power; and
an output capacitor connected between the output node and a ground node configured to receive a ground power, and
wherein based on an on duty ratio of each of the first control signal and the second control signal being greater than a reference value, a voltage level of the output power is greater than a voltage level of the input power, and based on the on duty ratio being less than or equal to the reference value, the voltage level of the output power is less than the voltage level of the input power.

20. The electronic device of claim 19, wherein based on the on duty ratio being greater than the reference value, the switching voltage has a voltage level between the voltage level of the input power and twice the voltage level of the input power; and
wherein based on the on duty ratio being less than or equal to the reference value, the switching voltage has the voltage level between a voltage level of the ground power and the voltage level of the input power.
